(19) United States
(12) Patent Application Publication
(10) Pub. No.: US 2016/0346159 A1
(43) Pub. Date: Dec. 1, 2016

(54) Ultimate Hair Scratcher

(71) Applicant: Marie Nicole Dixon, Baltimore, MD (US)

(72) Inventor: Marie Nicole Dixon, Baltimore, MD (US)

(21) Appl. No.: 14/466,243

(22) Filed: May 26, 2015

(51) Int. Cl. A61H 7/00

(52) U.S. Cl. CPC A61H 7/003; A61H 2205/021

(57) ABSTRACT

The invention is a hand held device used for scratching the scalp; while wearing certain hairstyles that does not allow one the ability to scratch their scalp by hand. This device provides immediate relief of itching associated with hair weaves and wigs. The invention provides temporary relief and relaxation for hard to reach areas of the scalp while wearing certain hairstyles. The invention provides consumers an easy and effective means of scratching an itchy scalp.

The invention is compact device which includes a thin point and an ornamental handle. An ornamental handle is located over the point and a detachable case maybe included to secure the point in a purse or pocket when not in use.

### BACKGROUND OF THE INVENTION

The invention is designed to immediately relieve itching in the scalp; while wearing certain hairstyles that are unable to be scratched by hand.

The invention is a compact device for scratching the scalp while wearing hair weaves wigs, braids, dreadlocks and other hairstyles which cannot be scratched by the use of one's hand.

In the treatment of an itching scalp, many devices are designed to massage the scalp without providing easy access too hard to reach areas of the scalp. These areas are often hidden by hair extensions, hair weaves, wigs, braids and other hairstyles which block access to the scalp and prevent easy access to the itchy areas.

In hair replacement hairstyles; which are presently very popular, namely hair weaves, wigs, braids and dreadlocks, there is a need for scratching the scalp while maintaining the secrecy of wearing fake hair.

It would be ideal to have a device that could be used to scratch the scalp of a person wearing weaves, wigs, braids, dreadlocks and other hairstyles that prevent easy access to the scalp without revealing that the person is wearing a hair replacement piece or a hair substitute.

Also, it would be advantageous to be able to use this same device for ornamental purposes which would allow the hair to be held in place when in an “up” hairstyle.

The invention is a compact device that can be carried in the purse of an individual so that it could be used whenever necessary.

### BRIEF SUMMARY OF THE PRESENT INVENTION

The invention is a hand held device used for scratching the scalp; while wearing certain hairstyles that do not allow one the ability to scratch their scalp by hand.

This device provides immediate relief of itching associated with hair weaves, wigs, braids and dreadlocks. The invention provides temporary relief and relaxation for hard to reach areas of the scalp while wearing certain hairstyles. The invention provides consumers an easy and effective means of scratching an itchy scalp.

The invention is compact device which includes a thin scalp-engaging tip and an ornamental handle. An ornamental handle is located over the point and engaged with the ornamental handle to position the point when it is not being used. A detachable case may be included to secure the point in a purse or pocket when not in use.

The objective of the device is to provide immediate relief of scalp itching associated with wearing hair weaves, wigs, braids, dreadlocks and other hairstyles which cannot be scratched by the use of one's hand.

Another objective of this invention is to provide a compact device for scalp itching without revealing that the person is wearing a hair replacement piece or hair substitute.

Having described my invention, I claim:

1. A compact device for scratching the scalp while wearing hair weaves wigs, braids, dreadlocks and other hairstyles which cannot be scratched by the use of one's hand.

2. Device according to claim 1, comprising an ornamental handle; a thin inflexible point, a curved scalp-engaging tip at the end of the point; and a detachable case to secure the point when not in use.

3. A device according to claim 1, wherein said ornamental handle allows the hair to be held in place when in an “up” hairstyle.

4. A device according to claim 1, wherein the ornamental handle consists of a lightweight plastic and the point consisting of an inflexible lightweight metal.
